(19) United States
(12) Patent Application Publication
(10) Pub. No.: US 2019/0369303 A1
(43) Pub. Date: Dec. 5, 2019

(54) Systems and Methods Incorporating Liquid Lenses

(71) Applicant: Ohio State Innovation Foundation, Columbus, OH (US)

(72) Inventors: Yi Zhao, Columbus, OH (US); Hanyang Huang, Columbus, OH (US)

(21) Appl. No.: 16/478,154

(22) PCT Filed: Feb. 16, 2018
(86) PCT No.: PCT/US2018/000009

§ 371 Date: Jul. 16, 2019

Related U.S. Application Data
(60) Provisional application No. 62/459,847, filed on Feb. 16, 2017.

(51) Int. Cl. G02B 3/14; G02B 7/04; G02C 7/08

(52) U.S. Cl. CPC G02B 3/14; G02C 7/085; G02B 7/04

(57) ABSTRACT

The present disclosure relates to systems and methods incorporating liquid lenses. One example embodiment includes an optical system that includes a support structure, an elastomeric membrane having a variable thickness profile, an optical component secured to the support structure, and a fluid disposed between the elastomeric membrane and the optical component. The variable thickness profile may be defined such that a center region of the elastomeric membrane has a different thickness than a peripheral region of the elastomeric membrane. A second example embodiment also includes an optical system. The second example embodiment includes a first elastomer-fluid lens and a second elastomer-fluid lens disposed about an optical axis and separated by a fixed distance. The two elastomer-fluid lenses may be configured such that collimated light entering the first elastomer-fluid lens is deflected according to a desired zoom factor, directed toward the second elastomer-fluid lens, and re-collimated by the second elastomer-fluid lens.

### CROSS-REFERENCE TO RELATED APPLICATIONS

The present application claims priority to Provisional Patent Application No. 62/459,847, filed with the U.S. Patent and Trademark Office on Feb. 16, 2017, the contents of which are hereby incorporated by reference.

### STATEMENT REGARDING FEDERALLY SPONSORED RESEARCH OR DEVELOPMENT

This invention was made with government support under award/project numbers 0954013/60023045, 1509727/60047548, and 1701038/60058138, awarded by the National Science Foundation. The government has certain rights in the invention.

### BACKGROUND

Unless otherwise indicated herein, the materials described in this section are not prior art to the claims in this application and are not admitted to be prior art by inclusion in this section.

An optical zoom system is an imaging system that changes its magnification or optical power while keeping its object plane and image plane fixed. Conventional zoom systems, e.g. the stereomicroscope, often have a zoom lens group comprising at least two solid lenses wherein their distances between each other can be adjusted using precise mechanisms such as cams or gears to alter the system's optical magnification. The mechanical motion of the optical elements, however, is costly and cumbersome, which compromises its further miniaturization of the optical zoom system and restricts its potential in space-limited applications.

Elastomer-fluid lenses refer to a group of adaptive optical components where a volume of fluid is encapsulated into a container with elastomeric membrane(s). As the fluidic pressure changes, the elastomeric membrane deforms and causes the shape change of the fluid, which in turn changes the optical powers. Elastomer-fluid lenses have been widely used for various optical applications due to their unique capabilities in changing the optical power without the need of displacing or replacing optical elements as is often required in conventional solid materials based optical systems.

However, the optical aberration increases with increasing deformation of the elastomeric membrane, which limits the applications of elastomer-fluid lenses in many applications, especially where the lens aperture is small and the optical power is high. This is largely due to the edge-clamping effect of the elastomeric membrane, which exhibits a fairly large spherical aberration at large deflection. Reducing optical aberrations of elastomer-fluid lenses, including spherical aberration, chromatic aberration, coma, astigmatism, and else, is significant for the adaptation of such fluid-based optical components in broader applications, especially those require limited spaces and high powers (e.g. imaging in mobile electronic devices).

### SUMMARY

The present disclosure is directed to systems and methods incorporating liquid lenses.

In a first example embodiment, the present disclosure relates to an optical system. The optical system includes a support structure. The optical system also includes an elastomeric membrane having a variable thickness profile. An optical axis passes through the elastomeric membrane. The elastomeric membrane is secured to the support structure. The variable thickness profile is defined such that a center region of the elastomeric membrane has a different thickness than a peripheral region of the elastomeric membrane. The variable thickness profile is asymmetric about the optical axis. The optical system further includes an optical component secured to the support structure. The optical axis passes through the optical component. Additionally, the optical system includes a fluid disposed in an interstice defined by a separation between the elastomeric membrane and the optical component. The fluid is confined by the support structure.

In a second example embodiment, the present disclosure relates to an optical system. The optical system includes a support structure. The optical system also includes an elastomeric membrane having a variable thickness profile. An optical axis passes through the elastomeric membrane. The elastomeric membrane is secured to the support structure. The variable thickness profile is defined such that a center region of the elastomeric membrane has a different thickness than a peripheral region of the elastomeric membrane. Further, the optical system includes an additional elastomeric membrane secured to the support structure. The optical axis passes through the additional elastomeric membrane. In addition, the optical system includes a fluid disposed in an interstice defined by a separation between the elastomeric membrane and the additional elastomeric membrane. The fluid is confined by the support structure.

In a third example embodiment, the present disclosure relates to an optical system. The optical system includes a support structure. The optical system also includes an elastomeric membrane having a variable thickness profile. An optical axis passes through the elastomeric membrane. The elastomeric membrane is secured to the support structure. The variable thickness profile is defined such that a center region of the elastomeric membrane has a different thickness than a peripheral region of the elastomeric membrane. In addition, the optical system includes an optical lens secured to the support structure. The optical axis passes through the optical lens. Further, the optical system includes a fluid disposed in an interstice defined by a separation between the elastomeric membrane and the optical lens. The fluid is confined by the support structure.

In a fourth example embodiment, the present disclosure relates to an optical system. The optical system includes a first elastomer-fluid lens that includes a first elastomeric membrane. The optical system also includes a second elastomer-fluid lens that includes a second elastomeric membrane. The first elastomer-fluid lens and the second elastomer-fluid lens are disposed about an optical axis and are separated by a fixed distance. The first elastomer-fluid lens is configured such that collimated light entering the first elastomer-fluid lens is deflected according to a desired zoom factor and is directed toward the second elastomer-fluid lens. The second elastomer-fluid lens is configured such that light from the first elastomer-fluid lens is re-collimated.

In a fifth example embodiment, the present disclosure relates to a method of zooming. The method includes determining a desired zoom factor. The method also includes adjusting an optical system based on the determined desired zoom factor. Adjusting the optical system includes adjusting a conformation of a first elastomeric membrane of a first elastomer-fluid lens to modify a focal length of the first elastomer-fluid lens. Adjusting the optical system also includes adjusting a conformation of a second elastomeric membrane of a second elastomer-fluid lens to modify a focal length of the second elastomer-fluid lens. The optical system is adjusted such that collimated light entering the first elastomer-fluid lens is deflected according to the determined desired zoom factor and is directed toward the second elastomer-fluid lens. Light directed to the second elastomer-fluid lens is re-collimated by the second elastomer-fluid lens.

### BRIEF DESCRIPTION OF THE FIGURES

FIG. 1A is a side-view illustration of an optical system, according to example embodiments.

FIG. 1B is a top-view illustration of an optical system, according to example embodiments.

FIG. 1C is a side-view illustration of an optical system, according to example embodiments.

FIG. 1D is an illustration of symmetric variable thickness profiles, according to example embodiments.

FIG. 1E is an illustration of asymmetric variable thickness profiles, according to example embodiments.

FIG. 1F is a side-view illustration of an optical system, according to example embodiments.

FIG. 2A is a side-view illustration of an optical system, according to example embodiments.

FIG. 2B is a top-view illustration of an optical system, according to example embodiments.

FIG. 2C is a side-view illustration of an optical system, according to example embodiments.

FIG. 3A is a side-view illustration of an optical system, according to example embodiments.

FIG. 3B is a top-view illustration of an optical system, according to example embodiments.

FIG. 3C is a side-view illustration of an optical system, according to example embodiments.

FIG. 4A is a perspective, cut-away illustration of an optical system, according to example embodiments.

FIG. 4B is a perspective, cut-away illustration of an optical system, according to example embodiments.

FIG. 5A is an illustration of a step in a mold-fabrication process, according to example embodiments.

FIG. 5B is an illustration of a step in a mold-fabrication process, according to example embodiments.

FIG. 5C is an illustration of a step in a mold-fabrication process, according to example embodiments.

FIG. 6A is a schematic illustration of an optical system, according to example embodiments.

FIG. 6B is a schematic illustration of an optical system, according to example embodiments.

FIG. 6C is a schematic illustration of an optical system, according to example embodiments.

FIG. 6D is a schematic illustration of an optical system, according to example embodiments.

FIG. 6E is a schematic illustration of an optical system, according to example embodiments.

FIG. 7A is a side-view illustration of an optical system, according to example embodiments.

FIG. 7B is a side-view illustration of an optical system, according to example embodiments.

FIG. 8A is a schematic illustration of an optical system, according to example embodiments.

FIG. 8B is a schematic illustration of an optical system, according to example embodiments.

FIG. 8C is a schematic illustration of an optical system, according to example embodiments.

FIG. 9A is a top-view, schematic illustration of an optical system, according to example embodiments.

FIG. 9B is a side-view, schematic illustration of an optical system, according to example embodiments.

FIG. 9C is an oblique view illustration of an optical system, according to example embodiments.

FIG. 10 is a flow chart illustration of a method, according to example embodiments.

FIG. 11 is a flow chart illustration of a method, according to example embodiments.

### DETAILED DESCRIPTION

Example methods and systems are described herein. Any example embodiment or feature described herein is not necessarily to be construed as preferred or advantageous over other embodiments or features. The example embodiments described herein are not meant to be limiting. It will be readily understood that certain aspects of the disclosed systems and methods can be arranged and combined in a wide variety of different configurations, all of which are contemplated herein.

Furthermore, the particular arrangements shown in the figures should not be viewed as limiting. It should be understood that other embodiments might include more or less of each element shown in a given figure. In addition, some of the illustrated elements may be combined or omitted. Similarly, an example embodiment may include elements that are not illustrated in the figures.

As used herein, the terms “magnify”, “magnification”, “magnification state”, “magnifying”, “magnified”, etc. are used broadly to describe the production of an image of an object that is larger or smaller than the object itself. Therefore, the term “magnify” and the like may be used to describe both an increase in image size (i.e., traditional magnification) and a decrease in image size (i.e., minification or traditional de-magnification). Thus, an optical magnification value corresponding to a “magnification” described herein may be greater or less than 1.0 in magnitude. Further, in some embodiments, the image may be inverted with respect to a “magnified” object (i.e., an optical magnification value corresponding to a “magnification” may be negative in sign).

While various elastomeric membranes may be described herein as being “round” elastomeric membranes, it is understood that any shape may be used interchangeably. For example, circular, oval, triangular, square, rectangular, pentagonal, hexagonal, heptagonal, octagonal, nonagonal, decagonal, etc. shapes could be used.

### I. Overview

Example embodiments may relate to systems and methods incorporating liquid lenses.

One example embodiment includes an optical system. The optical system may include an elastomer-fluid lens (i.e., an optical element that includes a fluid and an elastomeric membrane). The elastomer-fluid lens may include an elastomeric membrane (e.g., a circular or non-circular elastomeric membrane) having a variable thickness profile. Such membranes with variable thickness profiles may allow the optical system to have reduced optical aberration when compared to alternate optical systems using elastomer-fluid lenses that have an elastomeric membrane with a homogeneous thickness profile. The elastomeric membrane may be secured to a support structure. Further, the optical system may include an optical component also secured to the support structure. In addition, the optical system may include a fluid contained by the supported structure and located in between the optical component and the elastomeric membrane.

Specifically, in some example embodiments, the variable thickness profile may be defined such that a center region of the elastomeric membrane is different in thickness (e.g., thicker or thinner) than the peripheral region of the elastomeric membrane. Such a variable thickness profile may be designed through an iterative optomechanical analysis, yielding an optimized profile. Such a variable thickness profile may be designed to have small optical aberration within a range of desired optical powers. Optical systems of example embodiments may therefore be used in various imaging applications, for example.

The elastomeric membrane having the variable thickness profile can be fabricated using a wide spectrum of manufacturing approaches. For example, the elastomeric membrane may be fabricated by replication against a pre-fabricated master mold, which can be created using a wide spectrum of manufacturing technologies, including but not limited to, lithography, ultra-precision machining, diamond cutting, and diamond turning.

The iterative optomechanical analysis (i.e., optimization process) of example variable thickness profiles may include the following steps. First, for example, the variable thickness profile of the elastomeric membrane may be represented using a mathematical expression (e.g., a polynomial expression, such as a ninth-order polynomial expression), with a number of coefficients, which are to be determined through a regression procedure. An initialization value for each of the coefficients may then be provided. The variable thickness profile may then be analyzed using 3D modeling software. Next, the deformed variable thickness profile arising from various membrane center deflection conditions may then be estimated using numerical tools (such as finite element analysis). The deformed variable thickness profile is then extracted and input into optical stimulation tools (e.g., Zemax®) to estimate specific optical aberrations.

Such an optimization process may then be performed repeatedly and/or in an iterative fashion until the optical aberrations at a desired optical power or a desired range of optical power is sufficiently small (e.g., below a given threshold). The complementary shape (e.g., the negative shape) of the variable thickness profile may then be used to create a master mold to manufacture elastomeric membranes having the variable thickness profile.

Optical systems with such example elastomeric membranes having such variable thickness profiles (e.g., designed with an iterative optimization process as described herein) can allow for reduced optical aberration. Further the optical systems as described herein can accept high optical power while maintaining package sizes small enough for imaging purposes in space constraint applications, such as in mobile electronics devices and laparoendoscopic imaging devices.

Another example embodiment includes a second optical system. The second optical system may be used for optical zooming. The second optical system may include a first elastomer-fluid lens and a second elastomer-fluid lens, having a first elastomeric membrane and second elastomeric membrane, respectively. The first elastomer-fluid lens and/or the second elastomer-fluid lens may individually be similar to the optical system described above. Light may be emitted from the object, deflected by the first elastomer-fluid lens, and then deflected again by the second elastomer-fluid lens prior to reaching the image plane (e.g., after passing through a tube lens). In some embodiments, the light from the object may pass through an objective lens and become collimated before reaching the first elastomer-fluid lens.

The first elastomer-fluid lens and the second elastomer-fluid lens may be disposed about an optical axis and separated by a fixed distance. Further, the focal lengths of the first elastomer-fluid lens and/or the second elastomer-fluid lens may be adjustable. Such a configuration may allow for imaging with continuously variable zoom. The zoom factor may therefore depend on the focal length of the first elastomer-fluid lens and/or the focal length of the second elastomer-fluid lens, for example. Further, the zoom factor may depend upon the optical powers of one or both of the elastomer-fluid lenses. In some embodiments, the zoom factor may be between about 0.33 and about 3.0.

Some embodiments may further include an objective lens, a tube lens, an eyepiece, and/or a camera lens. The total magnification may also depend upon the optical powers of such additional lenses. In some embodiments, the sum of the focal lengths of the first elastomer-fluid lens and the second elastomer-fluid lens may be equal to the distance between the first elastomer-fluid lens and the second elastomer-fluid. Such a second optical system may be employed in microscopes, magnifiers, telescopes, and macroscopic imaging tools, for example.

### II. Example Systems

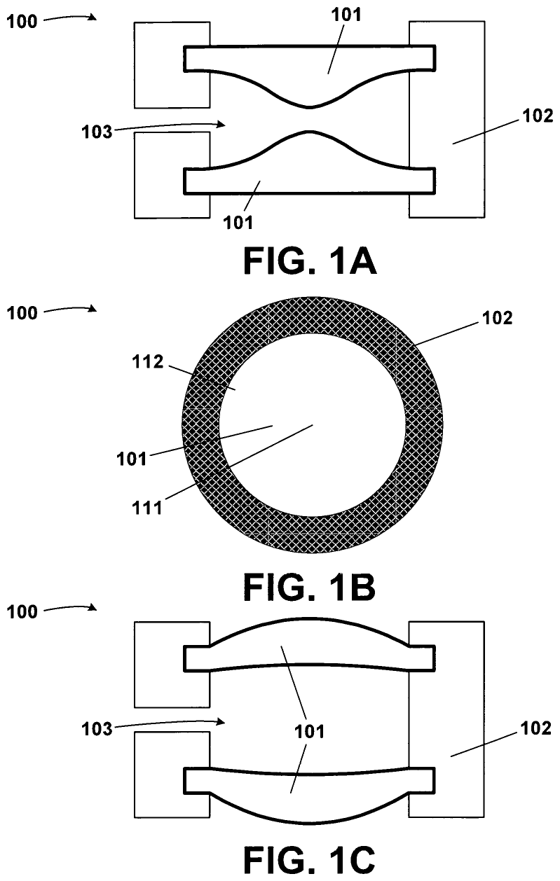

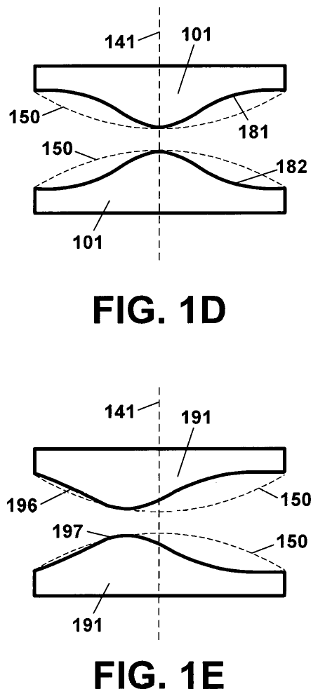

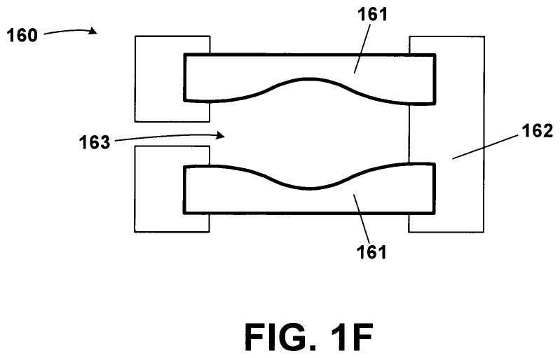

FIGS. 1A-5C illustrate optical systems, and methods of manufacture of such optical systems, that include elastomeric membranes having variable thickness profiles.

FIG. 1A is a side-view illustration of an optical system 100, according to example embodiments. The optical system 100 may include two elastomeric membranes 101 (one disposed near a top of the optical system 100, and one disposed near a bottom of the optical system 100). The elastomeric membranes 101 may have variable thickness profiles and may also be deformable. The elastomeric membranes 101 may be secured within the optical system 100 to a support structure 102. Further, either or both of the elastomeric membranes 101 may include a center region that has a different thickness (e.g., a greater thickness) than a peripheral region of the respective elastomeric membrane 101.

In some embodiments, the variable thickness profiles of the two elastomeric membranes 101 may be identical (e.g., a top elastomeric membrane 101 and a bottom elastomeric membrane 101 may each have the same variable thickness profiles). In some embodiments, the variable thickness profiles of the two elastomeric membranes 101 may not be identical (e.g., a top elastomeric membrane 101 may have a variable thickness profile and a bottom elastomeric membrane 101 may have an additional, i.e., its own, variable thickness profile).

In some embodiments, the variable thickness profile may be defined based on a thickness profile of a pre-fabricated master mold against which the elastomeric membrane was replicated. In some embodiments, the variable thickness profile may be defined by lithography, ultra-precision machining, diamond cutting, or diamond turning.

In some embodiments, the variable thickness profile may be defined according to an optimization process. The optimization process may include, for example: (i) defining a mathematical expression with a number of coefficients to describe the variable thickness profile; (ii) providing an initialization value for each of the coefficients; (iii) calculating an optical aberration at designed deformation resulting from the mathematical expression having coefficients with the initialization values; and (iv) replacing the initialization values with refined values that result from a regression procedure. Calculating the optical aberration may include applying a finite element model and a ray-tracing model. In some embodiments, the optimization process may further include: (i) calculating the optical aberration resulting from the mathematical expression having coefficients with the refined values; and (ii) replacing the refined values with further refined values that result from the regression procedure. In some embodiments, the elastomeric membrane may have a substantially circular shape with respect to an optical axis. Further, an optical component (e.g., an elastomeric membrane, an optical window, or a lens) may have a substantially circular shape with respect to the optical axis. In some embodiments, the elastomeric membrane may have a non-circular shape with respect to an optical axis. In addition, an optical component (e.g., an elastomeric membrane, an optical window, or a lens) may have a non-circular shape with respect to the optical axis. In some embodiments, the variable thickness profile may be defined such that the elastomeric membrane has an aspherical cross-section.

The illustration of FIG. 1A may be a cut-away illustration (i.e., the support structure 102 may wrap cylindrically around the periphery of the optical system 100, as illustrated from above in FIG. 1B). Further, the two elastomeric membranes 101 may define an interstice 103 that can contain fluid (e.g., optical fluid). Such optical fluid may also be contained by the support structure 102.

FIG. 1B is a top-view illustration of the optical system 100 illustrated in FIG. 1A, according to example embodiments. Illustrated in FIG. 1B are a center region 111 of the elastomeric membranes 101 and a peripheral region 112 of the elastomeric membranes 101.

FIG. 1C is a side-view illustration of the optical system 100 illustrated in FIG. 1A, according to example embodiments. The optical system 100 may be in an extended conformation (i.e., due to fluid pressure within the interstice 103). As illustrated, the elastomeric membranes 101 are deformed.

FIG. 1D is an illustration of symmetric variable thickness profiles of the elastomeric membranes, according to example embodiments. The top elastomeric membrane 101 has a top variable thickness profile 181. The bottom elastomeric membrane 101 has a bottom variable thickness profile 182. In some embodiments, the top variable thickness profile 181 and the bottom variable thickness profile 182 may be mirror images of one another (i.e., they are reflections of one another). In some embodiments, the top variable thickness profile 181 and the bottom variable thickness profile 182 may not be mirror images of one another (e.g., the two profiles could have different maximum thicknesses, different minimum thicknesses, and/or different profiles entirely). Also outlined are spherical thickness profiles 150 and a central optical axis 141, for reference. Thus, the top variable thickness profile 181 and the bottom variable thickness profile 182 are aspherical in cross-section.

Further, as illustrated, the top variable thickness profile 181 may be defined such that the top elastomeric membrane 101 has a planar surface (i.e., a substantially flat surface) on one side of the elastomeric membrane 101 and a non-planar surface (i.e., a not substantially flat surface) on another side of the elastomeric membrane 101. Similarly, the bottom variable thickness profile 182 may be defined such that the bottom elastomeric membrane 101 has a planar surface (i.e., a substantially flat surface) on one side of the elastomeric membrane 101 and a non-planar surface (i.e., a not substantially flat surface) on another side of the elastomeric membrane. The curvature of either side of an elastomeric membrane (e.g., the elastomeric membranes 101 of FIG. 1D) may be defined according to a curvature profile. The curvature profile may be based on the variable thickness profile (e.g., the respective variable thickness profile 181, 182 illustrated in FIG. 1D), in some embodiments. In some embodiments, the curvature profiles of the elastomeric membranes 101 of FIG. 1D may be identical. In other embodiments, the curvature profiles of the elastomeric membranes 101 of FIG. 1D may not be identical.

FIG. 1E is an illustration of asymmetric variable thickness profiles of the elastomeric membranes, according to example embodiments. As illustrated, the elastomeric membranes 191 of FIG. 1E have a top variable thickness profile 196 and a bottom variable thickness profile 197. As illustrated, these thickness profiles may be asymmetric about a central optical axis 141. Again, spherical thickness profiles 150 are illustrated for reference. Thus, the top variable thickness profile 196 and the bottom variable thickness profile 197 may be aspherical in cross-section, in addition to being asymmetric.

Further, as illustrated, the top variable thickness profile 196 may be defined such that the top elastomeric membrane 191 has a planar surface (i.e., a substantially flat surface) on one side of the elastomeric membrane 191 and a non-planar surface (i.e., a not substantially flat surface) on another side of the elastomeric membrane 191. Similarly, the bottom variable thickness profile 197 may be defined such that the bottom elastomeric membrane 191 has a planar surface (i.e., a substantially flat surface) on one side of the elastomeric membrane 191 and a non-planar surface (i.e., a not substantially flat surface) on another side of the elastomeric membrane. The curvature of either side of an elastomeric membrane (e.g., the elastomeric membranes 191 of FIG. 1E) may be defined according to a curvature profile. The curvature profile may be based on the variable thickness profile (e.g., the respective variable thickness profile 196, 197 illustrated in FIG. 1E), for example. In some embodiments, the curvature profiles of the elastomeric membranes 191 of FIG. 1E may be identical. In other embodiments, the curvature profiles of the elastomeric membranes 191 of FIG. 1E may not be identical.

FIG. 1F is a side-view illustration of an optical system 160, according to example embodiments. Similar to the optical system 100 illustrated in FIG. 1A, the optical system 160 may include two elastomeric membranes 161 (one disposed near a top of the optical system 160, and one disposed near a bottom of the optical system 160). The elastomeric membranes 161 may have variable thickness profiles and may also be deformable. The elastomeric membranes 161 may be secured within the optical system 160 to a support structure 162. Further, either or both of the elastomeric membranes 161 may include a center region that has a different thickness (e.g., a lesser thickness) than a peripheral region of the respective elastomeric membrane 161.

In some embodiments, the variable thickness profiles of the two elastomeric membranes 161 may be identical (e.g., a top elastomeric membrane 161 and a bottom elastomeric membrane 161 may each have the same variable thickness profiles). In some embodiments, the variable thickness profiles of the two elastomeric membranes 161 may not be identical (e.g., a top elastomeric membrane 161 may have a variable thickness profile and a bottom elastomeric membrane 161 may have an additional, i.e., its own, variable thickness profile). In addition, the variable thickness profiles of the two elastomeric membranes 161 may be defined according to any of the fabrication techniques described with respect to FIG. 1A.

The illustration of FIG. 1F may be a cut-away illustration (i.e., the support structure 162 may wrap cylindrically around the periphery of the optical system 160). Further, the two elastomeric membranes 161 may define an interstice 163 that can contain fluid (e.g., optical fluid). Such optical fluid may also be contained by the support structure 162.

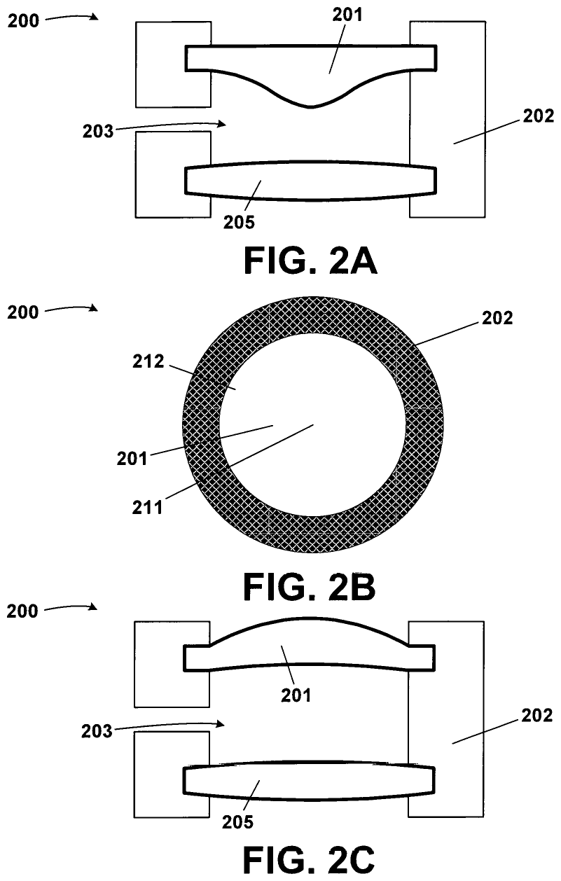

FIG. 2A is a side-view illustration of an optical system 200, according to example embodiments. The optical system 200 may include an elastomeric membrane 201 and a lens 205. The lens 205 may be a biconvex lens, as illustrated. Other types of lens are also possible. Here, the lens 205 may be an example of an optical component. The elastomeric membrane 201 may have a variable thickness profile and may also be deformable. The elastomeric membrane 201 may be secured within the optical system 200 to a support structure 202. The illustration of FIG. 2A may be a cut-away illustration (i.e., the support structure 202 may wrap cylindrically around the periphery of the optical system 200, as illustrated from above in FIG. 2B). Further, the elastomeric membrane 201 and the lens 205 may define an interstice 203 that can contain fluid (e.g., optical fluid). Such optical fluid may also be contained by the support structure 202.

FIG. 2B is a top-view illustration of the optical system 200 illustrated in FIG. 2A, according to example embodiments. Illustrated in FIG. 2B are a center region 211 of the elastomeric membrane 201 and a peripheral region 212 of the elastomeric membrane 201.

FIG. 2C is a side-view illustration of the optical system 200 illustrated in FIG. 2A, according to example embodiments. The optical system 200 may be in an extended conformation (i.e., due to fluid pressure within the interstice 203). As illustrated, the elastomeric membrane 201 is deformed.

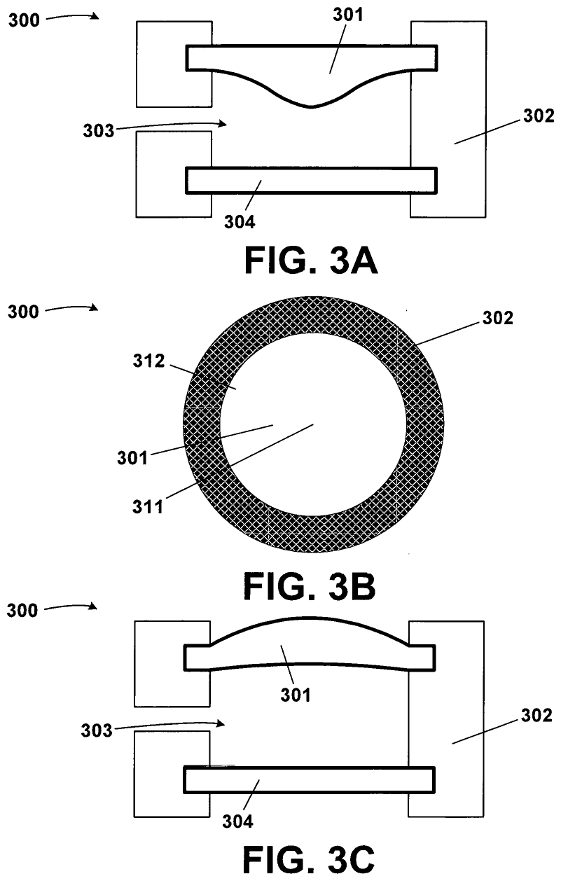

FIG. 3A is a side-view illustration of an optical system 300, according to example embodiments. The optical system 300 may include an elastomeric membrane 301 and an optical window 304. The optical window 304 may be a glass plate, for example. As illustrated, the glass plate may be planar. Other types of optical windows are also possible. Here, the optical window 304 may be an example of an optical component. The elastomeric membrane 301 may have a variable thickness profile and may also be deformable. The elastomeric membrane 301 may be secured within the optical system 300 to a support structure 302. The illustration of FIG. 3A may be a cut-away illustration (i.e., the support structure 302 may wrap cylindrically around the periphery of the optical system 300, as illustrated from above in FIG. 3B). Further, the elastomeric membrane 301 and the optical window 304 may define an interstice 303 that can contain fluid (e.g., optical fluid). Such optical fluid may also be contained by the support structure 302.

FIG. 3B is a top-view illustration of the optical system 300 illustrated in FIG. 3A, according to example embodiments. Illustrated in FIG. 3B are a center region 311 of the elastomeric membrane 301 and a peripheral region 312 of the elastomeric membrane 301.

FIG. 3C is a side-view illustration of the optical system 300 illustrated in FIG. 3A, according to example embodiments. The optical system 300 may be in an extended conformation (i.e., due to fluid pressure within the interstice 303). As illustrated, the elastomeric membrane 301 is deformed.

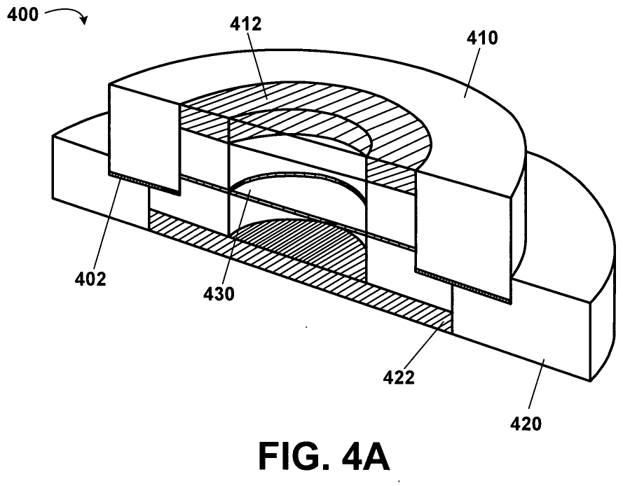

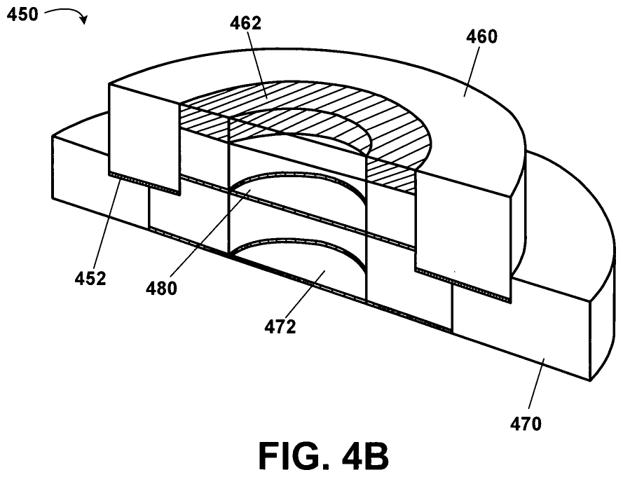

FIG. 4A is a perspective, cut-away illustration of an optical system 400, according to example embodiments. The optical system 400 may include a top cover glass 412, a top mounting cell 410, one or more adhesives 402, an elastomeric membrane 430, a bottom cover glass 422, and a bottom mounting cell 420. The elastomeric membrane 430 and the bottom cover glass 422 may be analogous to the elastomeric membrane 301 and the optical window 304 illustrated in FIGS. 3A-3C, for example. Further, the top cover glass 412 and/or the bottom cover glass 422 may serve to protect the optical system 400 from damage. In addition, an interstice between the elastomeric membrane 430 and the bottom cover glass 422 may encapsulate optical fluid. In some embodiments, the bottom cover glass 422 may provide optical power as well.

FIG. 4B is a perspective, cut-away illustration of an optical system 450, according to example embodiments. The optical system 450 may include a top cover glass 462, a top mounting cell 460, one or more adhesives 452, a first elastomeric membrane 480, a second elastomeric membrane 472, and a bottom mounting cell 470. The first elastomeric membrane 480 and the second elastomeric membrane 472 may be analogous to the elastomeric membranes 101 illustrated in FIGS. 1A-1D, the elastomeric membranes 191 illustrated in FIG. 1E, or the elastomeric membranes 161 illustrated in FIG. 1F, for example. Further, the top cover glass 462 may serve to protect the optical system 450 from damage. In addition, an interstice between the first elastomeric membrane 480 and the second elastomeric membrane 472 may encapsulate optical fluid.

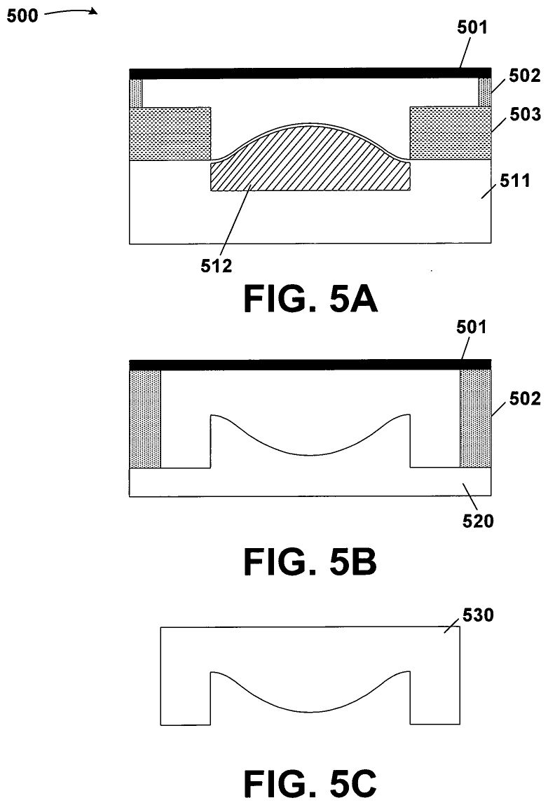

FIG. 5A is an illustration of a step in a mold-fabrication process, according to example embodiments. FIG. 5A may represent a first step in the process of fabricating a master mold, for example. As illustrated, a glass slide 501, a spacer 502, a ring 503 (e.g., made of PDMS), and an elastomer-fluid lens (including a support structure 511 and a fluid 512, for example) may be used in the first step of the fabrication process.

FIG. 5B is an illustration of a step in a mold-fabrication process, according to example embodiments. FIG. 5B may represent a second step in the process of fabricating a master mold, for example. As illustrated, a glass slide 501, a spacer 502, and a first mold 520 may be used in the second step of the fabrication process.

FIG. 5C is an illustration of a step in a mold-fabrication process, according to example embodiments. FIG. 5C may represent a third step in the process of fabricating a master mold, for example. As illustrated, a second mold 530 may be created during the third step of the fabrication process.

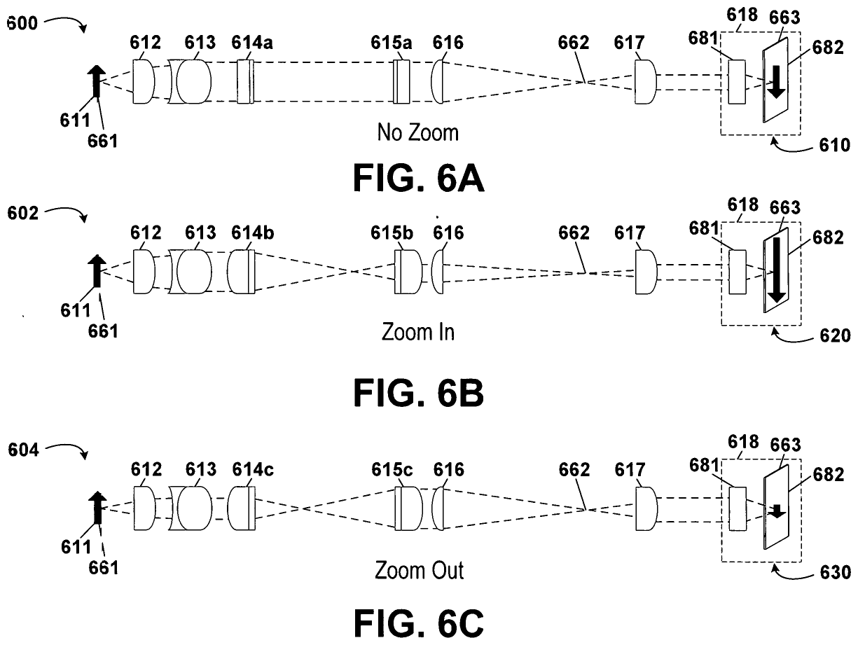

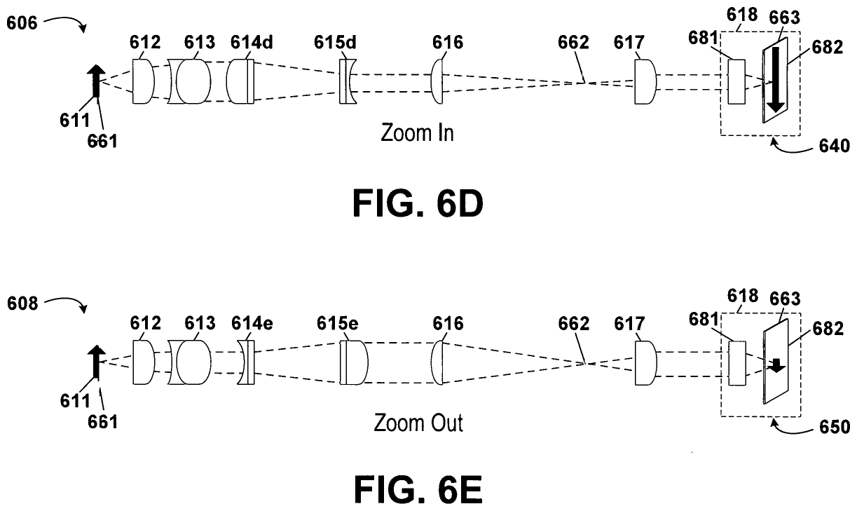

FIGS. 6A-9C illustrate an optical magnification system that utilizes two or more elastomer-fluid lenses.

The optical magnification system may have tunable magnification and may include an optical axis, object 611 (with corresponding object plane 661), an objective 612, 613, a first elastomer-fluid lens 614a, 614b, 614c, 614d, 614e, a second elastomer-fluid lens 615a, 615b, 615c, 615d, 615e, a tube lens 616, an intermediate plane 662, an eyepiece 617 and a camera module 618 having a camera lens 681 and a camera sensor 682 (with corresponding image plane 663).

The objective 612, 613 placed after the object 611 on the optical axis first may collimate light rays from the object 611 within the field of view of the camera sensor 682. As illustrated in FIG. 6A, the optical magnification system 600 may be in a no-zoom configuration. Similarly, as illustrated in FIG. 6B, the optical magnification system 602 may be in a zoom-in configuration. In addition, as illustrated in FIG. 6C, the optical magnification system 604 may be in a zoom-out configuration. Further, as illustrated in FIG. 6D, the optical magnification system 606 may be in a zoom-in configuration. Still further, as illustrated in FIG. 6E, the optical magnification system 608 may be in a zoom-out configuration.

The first elastomer-fluid lens 614a, 614b, 614c, 614d, 614e and the second elastomer-fluid lens 615a, 615b, 615c, 615d, 615e may work simultaneously to form a zoom lens group whereby the optical magnification system can be tuned while keeping the image plane 663 stationary. The first elastomer-fluid lens 614a, 614b, 614c, 614d, 614e may focus the collimated light rays from the objective 612, 613 to the focal plane of the second elastomer-fluid lens 615a, 615b, 615c, 615d, 615e. Further, the light rays may be re-collimated after passing through the second elastomer-fluid lens 615a, 615b, 615c, 615d, 615e.

The eyepiece 617 may be utilized in the optical magnification systems 600, 602, 604 similarly to an eyepiece in a conventional microscope. Light rays may be collimated by the eyepiece, and render a final image onto the camera sensor 682 by the camera lens 681.

The objectives 612, 613 may use high optical power to magnify. The optical system may also include at least two fixed lenses as objective lenses. The objective lenses may be made of transparent rigid materials, such as glass, poly(methyl methacrylate) (PMMA), or polycarbonate. The objective lenses may also have a high numerical aperture to improve the optical resolution of the system (e.g., between 0.5 and 1.0 or between 0.1 and 1.25). Additionally, aspherical or achromatic lenses may be combined in the optical system to correct various optical aberrations such as spherical aberrations, chromatic aberrations, etc.

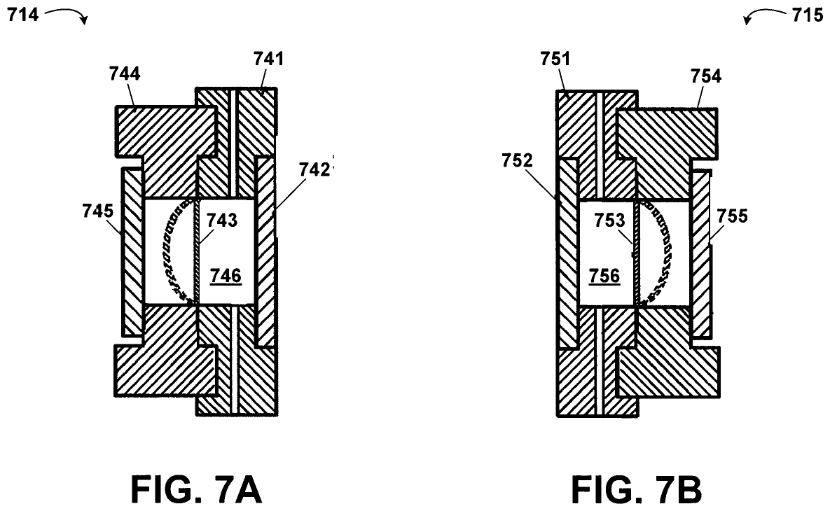

The first elastomer-fluid lens 614a, 614b, 614c, 614d, 614e may be arranged after the objective lenses 612, 613 and focuses the collimated light. For example, the first elastomer-fluid lens 614a, 614b, 614c, 614d, 614e may take the form of the first elastomer-fluid lens 714 illustrated in FIG. 7A. The first elastomer-fluid lens 714 may include a first fixed chamber 741, a first fixed lid 744, a first fixed plate 742, a first elastomeric membrane 743, and a first optical fluid 746. In some embodiments, the first elastomeric membrane 743 may have a circular shape. In some embodiments, the first elastomeric membrane 743 may have a non-circular shape. The first fixed chamber 741 may be made of opaque rigid materials that are not deformable by a maximum differential pressure within the first fixed chamber 741. The first fixed chamber 741 may include a bump structure on the membrane side in order to provide a pre-strain on the first elastomeric membrane 743. The pre-strain can prevent undesired wrinkle structures on the peripheries of the first elastomeric membrane 743 and increase the deforming uniformity. Such a design may further improve the optical quality of the optical system. The first fixed lid 744 fits and bonds well with the first fixed chamber 741 to provide the pre-strain. On top of the first fixed lid 744 there may be a first cover plate 745. The first cover plate 745 may prevent the first elastomeric membrane 743 from any pollution, scratch, damage, or touch. The first elastomeric membrane 743 may be made of an elastomeric material having specific characteristics. For example, the elastomeric material may be transparent, stable, and, in particular, elastically deformable.

On the other side of the first fixed chamber 741 is a first fixed plate 742 made of transparent rigid material. Thus, by changing the differential pressure across the first elastomeric membrane 743, the focal length of the first elastomer-fluid lens 714 can be changed.

In one embodiment, the optical quality of the first elastomer-fluid lens 714 can be improved by changing the cross section of the first deformable elastomeric membrane 743. The first elastomeric membrane 743 may have a variable thickness profile with different center thickness and peripheral thickness. By precisely selecting such contours and parameters, the optical aberration (e.g., spherical aberration, field curvature, or distortion) can be reduced.

In an example embodiment, the first fixed plate 742 may be made of a transparent rigid material having a planar, spherical, or aspherical cross-sectional profile and different center thickness and peripheral thickness. The first elastomer-fluid lens 714 can be in the form of a plano-convex, plano-concave, biconvex, and meniscus lens. By precisely selecting such contours and parameters, the optical quality of the first elastomer-fluid lens 714 and the zoom system can be further enhanced. Alternatively, the first fixed plate 742 may be replaced by an elastomeric membrane.

The optical magnification systems 600, 602, 604, 606, 608 also includes a second elastomer-fluid lens 615a, 61b, 615c, 615d, 615e that may have the same focal position as the first elastomer-fluid lens 614a, 614b, 614c, 614d, 614e. The focused light may be collimated again after passing through the second elastomer-fluid lens 615a, 615b, 615c, 615d, 615e. For example, the second elastomer-fluid lens 615a, 615b, 615c, 615d, 615e may take the form of the second elastomer-fluid lens 715 illustrated in FIG. 7B. The second elastomer-fluid lens 715 may include a second fixed chamber 751, a second fixed lid 754, a second fixed plate 752, a second elastomeric membrane 753, and a second optical fluid 756. In some embodiments, the first elastomeric membrane 743 may have a circular shape. In some embodiments, the first elastomeric membrane 743 may have a non-circular shape. The second fixed chamber 751 may also be made of opaque rigid materials, similar to the first fixed chamber 741. The second fixed chamber 751 may similarly include a bump structure on the second elastomeric membrane side in order to provide a pre-strain on the second elastomeric membrane 753. The second fixed lid 754 may provide the pre-strain on the second elastomeric membrane 753. On top of the second fixed lid 754 is a second cover plate 755 to help prevent the second elastomeric membrane 753 from any pollution, scratch, damage or touch.

The second elastomeric membrane 753 may be made of a transparent elastomeric material. On the other side of the second fixed chamber 751 is a second fixed plate 752 made of a transparent rigid material. Thus, by changing the differential pressure across the second elastomeric membrane 753, the focal length of the second elastomer-fluid lens 715 can be changed.

In an example embodiment, the optical quality of the second elastomer-fluid lens 715 can be improved by changing the cross section of the second elastomeric membrane 753. The second elastomeric membrane 753 can have a variable thickness profile with different center thickness and peripheral thickness. By precisely selecting such contours and parameters, the optical aberration (e.g., spherical aberration, field curvature, or distortion) can be reduced.

In an example embodiment, the second fixed plate 752 made of transparent rigid material can have a planar, spherical, or an aspherical cross-sectional profile and different center thickness and peripheral thickness. The second elastomer-fluid lens 715 can be in the form of a plano-convex, plano-concave, biconvex, and meniscus lens. By precisely selecting such contours and parameters, the optical quality of the second elastomer-fluid lens 715 and the optical magnification system can be further enhanced. Alternatively, the second fixed plate 752 may be replaced by an elastomeric membrane.

The optical fluid 746, 756 in the elastomer-fluid lenses 714, 715 may have a high abbe number (e.g., larger than 50 or larger than 30). The optical fluid 746, 756 may be encapsulated within the chamber (i.e., the support structure) by the elastomeric membrane and the fixed plate. The lid and the pre-strain structure may further help to prevent the leakage of the optical fluid. A high abbe number of the fluid may provide a high light transmission and, thus, a better optical quality of the optical system. The optical fluid may have a close refractive index to that of the elastomeric membrane (e.g., the difference is within 0.5 from the elastomeric membrane). Further, the fluid may be stable, nonvolatile, freeze-resistant, heat-resistant, have low viscosity (e.g., between 0.5 and 20.0 mPa·s), and/or not react with the elastomeric membrane material.

The optical magnification systems 600, 602, 604, 606, 608 may achieve an optical zoom effect by tuning the focal length of the first elastomer-fluid lens 614a, 614b, 614c, 614d, 614e and the second elastomer-fluid lens 615a, 615b, 615c, 615d, 615e, simultaneously. The first elastomeric membrane 743 of the first elastomer-fluid lens 714 is oriented towards the object plane while the second elastomeric membrane 753 of the second elastomer-fluid lens 715 is oriented towards the image plane. The first cover plate 745 of the first elastomer-fluid lens 714 is oriented towards the image plane while the second cover plate 755 of the second elastomer-fluid lens 715 is oriented towards the object plane. This arrangement is determined by the direction of the entrance collimated light. Thus, the optical quality of the elastomer-fluid lenses 714, 715 can be improved.

The elastomer-fluid zoom lens group 800 may have a variable zoom power. Each of the elastomer-fluid lenses may offer a single deformable surface to vary optical power. The front surface 841 of the first elastomer-fluid lens may have a variable thickness profile. The back surface 844 of the second elastomer-fluid lens may also have a variable thickness profile. The back surface 842 of the first elastomer-fluid lens and the front surface 843 of the second elastomer-fluid lens may be fixed plates with no power. The thickness of the first elastomer-fluid lens and the second elastomer-fluid lens do not affect the lens power, but the position of the optical system's principal plane. The first elastomer-fluid lens and the second elastomer-fluid lens may be modeled as thin lenses. According to geometrical optics, the net power of such a zoom lens group in free space is given by:

$${P}_{zoom} = {P}_{1} + {P}_{2} - {P}_{1} {P}_{2} D = \frac{1}{{f}_{1}} + \frac{1}{{f}_{2}} - \frac{D}{{f}_{1} {f}_{2}}$$

where P_{zoom} is the optical power of the zoom lens group, P₁ and f₁ are the power and focal length of the first elastomer-fluid lens, P₂ and f₂ are the power and focal length of the second elastomer-fluid lens, D is the distance between the first elastomer-fluid lens and the second elastomer-fluid lens.

In order to keep the afocal relation between the two elastomer-fluid lenses, the distance D in between must satisfy D=f₁+f₂. In some embodiments, the distance (D) may be fixed. Further, the zoom factor of the zoom lens group may be modified by adjusting the focal lengths (f₁ and f₂) of both of the elastomer-fluid lenses, rather than by adjusting the distance (D) between the two elastomer-fluid lenses. Each of the elastomer-fluid lenses may be tuned independently in power to achieve such a relation. The optical system that includes the present zoom configuration has a tunable zoom ratio R=f₁/f₂. When R<1, the system is in a zoom-out configuration. When R>1, the system is in a zoom-in configuration.

In an example embodiment, the optical system provides a continuous plurality of zoom factors. The fixed distance between first elastomer-fluid lens and the second elastomer-fluid lens can be shorter (e.g., smaller than 100 mm) than that of an optical zoom system using liquid crystal lenses (e.g., larger than 500 mm), without compromising the zoom ratio. This may enhance the applicability of the optical system, especially in space-limited fields.

In an example embodiment, the optical system has a small f-number (f/#). The f-number of the optical system may be defined as a focal length of the optical system divided by a diameter of an aperture defined by an elastomer-fluid lens. Embodiments having small f-numbers may improve the resolution of the optical system and enable a decreased depth of field, which may be applicable for microscopic systems.

The focal length range for the elastomer-fluid lens may make the actuation system miniaturizable. An example embodiment of the optical system comprises at least one actuator, in particular two independent actuators. The actuators may be actuated electrically, magnetically, mechanically, pneumatically, thermally, piezoelectrically, or in response to a stimuli.

The actuators can be made miniaturized, simple, fast, and under a low power consumption, such as an electrostatic actuator, electromagnetic actuator, or a piezoelectric actuator.

The first elastomer-fluid lens and the second elastomer-fluid lens may be, respectively, connected with the actuators. The focal length of the elastomer-fluid lens can be changed by changing the differential pressure within the chamber. One way is to pump optical fluid into the chamber to increase the fluid volume. Thus, the focal length can be tuned in a wide range. The first elastomer-fluid lens and the second elastomer-fluid lens may work independently from each other by means of two independent actuators. This may makes the optical zoom system applicable to other various optical applications.

The fixed tube lens may be made of a rigid material and may be arranged after the second elastomer-fluid lens. The tube lens may have a long focal length (e.g., larger than 100 mm). The long focal length of the tube lens combined with the, relatively, short focal length of the objective may set an initial magnification. In an example embodiment, the position of the intermediate plane may be determined by the focal length of the tube lens.

The optical system may also include a fixed eyepiece made of rigid material arranged after the intermediate plane. The divergent light rays from the tube lens may be collimated again by the eyepiece before entering a camera module. The eyepiece may include at least one fixed lens made of rigid material. The focal length of the eyepiece may be similar to that of the camera lens.

In an example embodiment, the introduction of eyepiece helps to maintain the magnification of the optical system when imaging onto the camera sensor. The eyepiece may be an aspheric lens, an achromatic lens, or a reversed camera lens similar to those found within the camera module. The curved surface of the eyepiece may be oriented towards the camera lens to improve the image quality on the camera sensor.

In one example embodiment of the optical system, the light rays either enter or exit each lens as collimated light. The distance between the elements that collimated light is travelling may not affect the zoom factor, such as the distance between the objective lens and the first elastomer-fluid lens, between the second elastomer-fluid lens and the tube lens, or between the eyepiece and the camera lens.

In an example embodiment of the optical system, the optical system may include mirror(s) that are tilted 45 degrees towards the vertical plane (e.g., between 40 degrees and 50 degrees with respect to the vertical plane). In particular, the optical system may include at least one mirror oriented towards the second elastomeric membrane of the second elastomer-fluid lens, wherein at least one of the mirrors may be oriented towards the camera lens. In some embodiments, at least one mirror may direct collimated light from the second elastomer-fluid lens to a camera sensor (e.g., when the optical axis does not intersect the image plane)

In some embodiments, the overall optical path is diverted at least twice, in some embodiments three times. Thus, the optical system can be further miniaturized, in particular with a smaller system length. This may improve applicability of the optical system, especially in space limited fields.

The optical zoom system may include a mirror that is tilted 45 degrees towards the horizontal plane (e.g., at an angle between 40 degrees and 50 degrees). The direction of the optical axis may change the orientation of the eyepiece and the camera module. Thus the camera module can be arranged to be horizontally placed. This may make the overall configuration more compact and miniaturized.

The optical zoom system can be adapted to a smartphone, a tablet, or any mobile device that comprise a camera module. This further increases the applicability and versatility of the optical system in different areas.

FIGS. 6A-6E are schematic illustrations of optical magnification systems 600, 602, 604, 606, 608, according to example embodiments. FIG. 6A shows an optical magnification system 600 in a no zoom configuration, FIG. 6B shows an optical magnification system 602 in a zoom-in configuration, FIG. 6C shows an optical magnification system 604 in zoom-out configuration, FIG. 6D shows an optical magnification system 606 in a zoom-in configuration, and FIG. 6E shows an optical magnification system 608 in a zoom-out configuration.

In FIGS. 6A-6E, reference numeral 611 refers to an object, reference numeral 661 refers to an object plane, reference numeral 612 refers to an aspheric lens, reference numeral 613 refers to an achromatic lens, reference numeral 616 refers to a tube lens, reference numeral 662 refers to an intermediate plane, reference numeral 617 refers to an eyepiece, reference numeral 618 refers to a camera module (the camera module having a camera lens 681, a camera sensor 682), and reference numeral 663 refers to the image plane.

In FIG. 6A, reference numeral 614a refers to a first elastomer-fluid lens provided with no power (thus in a flat conformation), reference numeral 615a refers to a second elastomer-fluid lens provided with no power (thus in a flat conformation), and reference numeral 610 refers to an image of the object 611 where no zoom has taken place.

In FIG. 6B, reference numeral 614b refers to a first elastomer-fluid lens provided with power with a given focal length, reference numeral 615b refers to a second elastomer-fluid lens provided with power with a given focal length (shorter than that of the first elastomer-fluid lens), and reference numeral 620 refers to an image of the object 611 where a zoom in has taken place.

In FIG. 6C, reference numeral 614c refers to a first elastomer-fluid lens provided with power with a given focal length, reference numeral 615c refers to a second elastomer-fluid lens provided with power with a given focal length (longer than that of the first elastomer-fluid lens), and reference numeral 630 refers to an image of the object 611 where a zoom out has taken place.

In FIG. 6D, reference numeral 614d refers to a first elastomer-fluid lens provided with power with a given focal length, reference numeral 615d refers to a second elastomer-fluid lens provided with power with a given focal length (shorter than that of the first elastomer-fluid lens), and reference numeral 640 refers to an image of the object 611 where a zoom in has taken place.

In FIG. 6E, reference numeral 614e refers to a first elastomer-fluid lens provided with power with a given focal length, reference numeral 615e refers to a second elastomer-fluid lens provided with power with a given focal length (longer than that of the first elastomer-fluid lens), and reference numeral 650 refers to an image of the object 611 where a zoom out has taken place.

FIGS. 7A and 7B show a detailed schematic configuration of the first elastomer-fluid lens 714 and the second elastomer-fluid lens 715.

The first elastomer-fluid lens 714 includes a first fixed chamber 741, a first fixed lid 744, a first fixed plate 742, a first elastomeric membrane 743, a first optical fluid 746, and a first cover plate 745. The first fixed chamber 741 is made of an opaque rigid material that does not permit the transmission of light.

The second elastomer-fluid lens 715 includes a second fixed chamber 751, a second fixed lid 754, a second cover plate 752, a second elastomeric membrane 753, a second optical fluid 756, and a transparent cover plate 755. The second fixed chamber 751 is made of an opaque rigid material that does not permit the transmission of light.

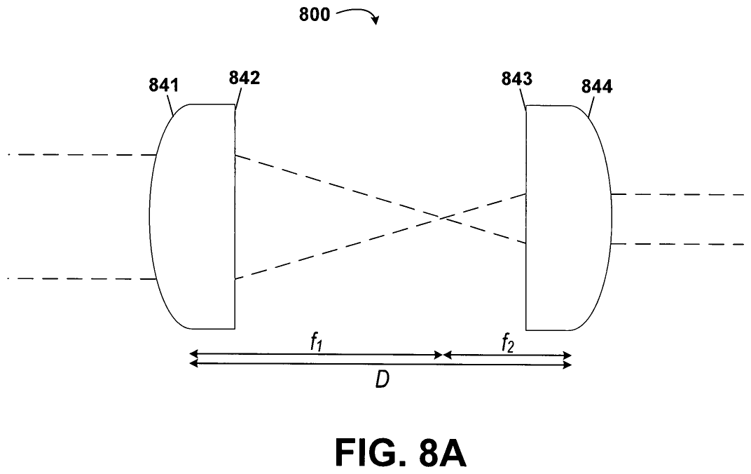

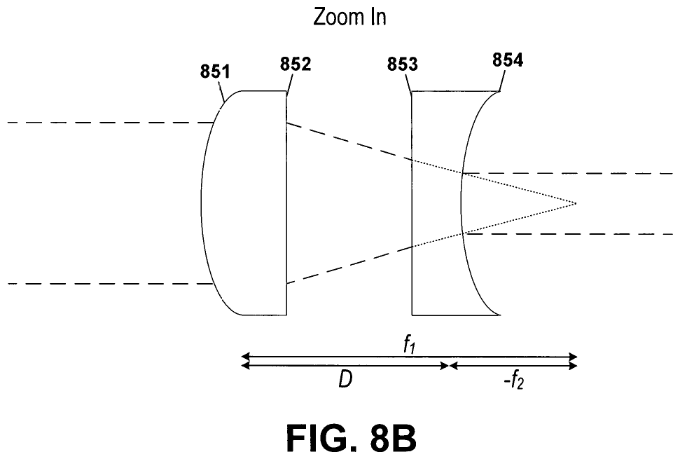

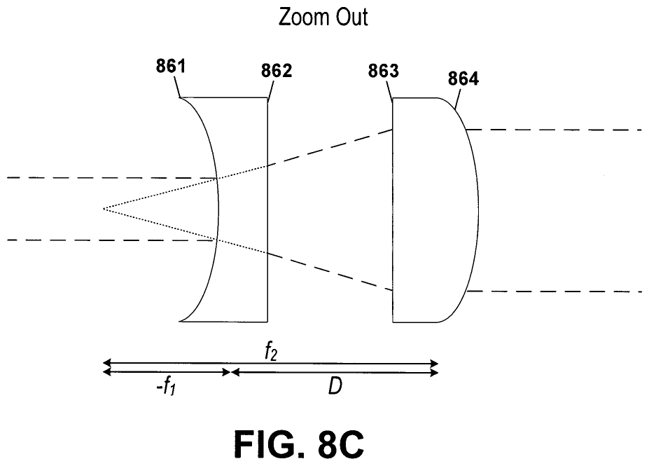

FIG. 8A is a schematic illustration of an optical system, according to example embodiments. FIG. 8A illustrates a zoom lens configuration using the first elastomer-fluid lens and the second elastomer-fluid lens. As illustrated, the distance between the two elastomer-fluid lenses (D) is equal to the sum of the focal lengths (fond f₂) of the respective elastomer-fluid lenses (i.e., D=f₁+f₂). Surface 841 is a surface with a variable thickness profile of the first elastomer-fluid lens, surface 844 is a surface with a variable thickness profile of the second elastomer-fluid lens, surface 842 is a fixed plate with no optical power for the first elastomer-fluid lens, and surface 843 is a fixed plate with no optical power for the second elastomer-fluid lens.

Similarly, FIG. 8B is a schematic illustration of an optical system, according to example embodiments. FIG. 8B illustrates a zoom lens configuration (e.g., a zoom-in configuration) using a first elastomer-fluid lens and a second elastomer-fluid lens. As in FIG. 8A, the first elastomer-fluid lens is plano-convex. However, unlike FIG. 8A, the second elastomer-fluid lens is plano-concave. Additionally, the distance between the two elastomer-fluid lenses (D) is equal to the sum of the focal lengths (fond f₂) of the respective elastomer-fluid lenses (e.g., D=f₁+f₂). Because the second elastomer-fluid lens is plano-concave, the focal length of the second elastomer-fluid lens may be negative, for example. As such, the distance between the two elastomer-fluid lenses (D) in FIG. 8B may be less than the distance between the two elastomer-fluid lenses (D) in FIG. 8A. Surface 851 is a surface with a variable thickness profile of the first elastomer-fluid lens, surface 854 is a surface with a variable thickness profile of the second elastomer-fluid lens, surface 852 is a fixed plate with no optical power for the first elastomer-fluid lens, and surface 853 is a fixed plate with no optical power for the second elastomer-fluid lens.

Additionally, FIG. 8C is a schematic illustration of an optical system, according to example embodiments. FIG. 8C illustrates a zoom lens configuration (e.g., a zoom-out configuration) using a first elastomer-fluid lens and a second elastomer-fluid lens. As in FIG. 8A, the second elastomer-fluid lens is plano-convex. However, unlike FIG. 8A, the first elastomer-fluid lens is plano-concave. Additionally, the distance between the two elastomer-fluid lenses (D) is equal to the sum of the focal lengths (fond f₂) of the respective elastomer-fluid lenses (e.g., D=f₁+f₂). Because the first elastomer-fluid lens is plano-concave, the focal length of the first elastomer-fluid lens may be negative, for example. As such, the distance between the two elastomer-fluid lenses (D) in FIG. 8C may be less than the distance between the two elastomer-fluid lenses (D) in FIG. 8A. Surface 861 is a surface with a variable thickness profile of the first elastomer-fluid lens, surface 864 is a surface with a variable thickness profile of the second elastomer-fluid lens, surface 862 is a fixed plate with no optical power for the first elastomer-fluid lens, and surface 863 is a fixed plate with no optical power for the second elastomer-fluid lens.

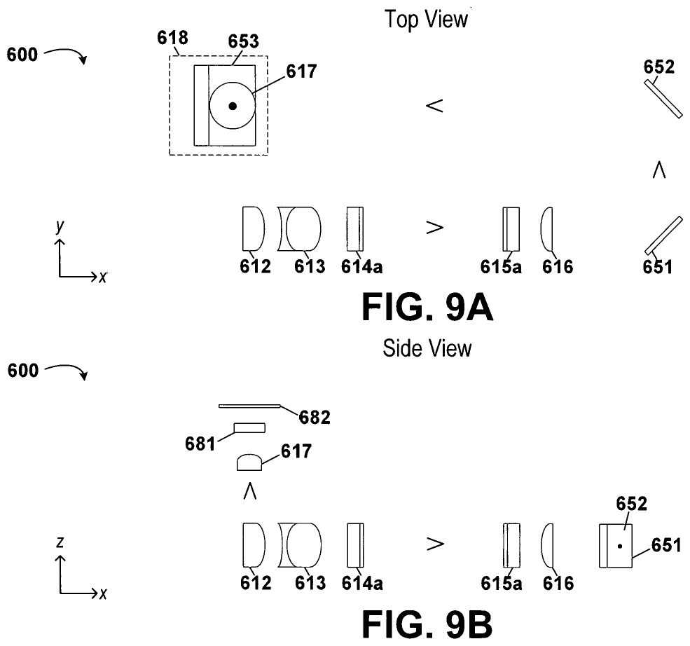

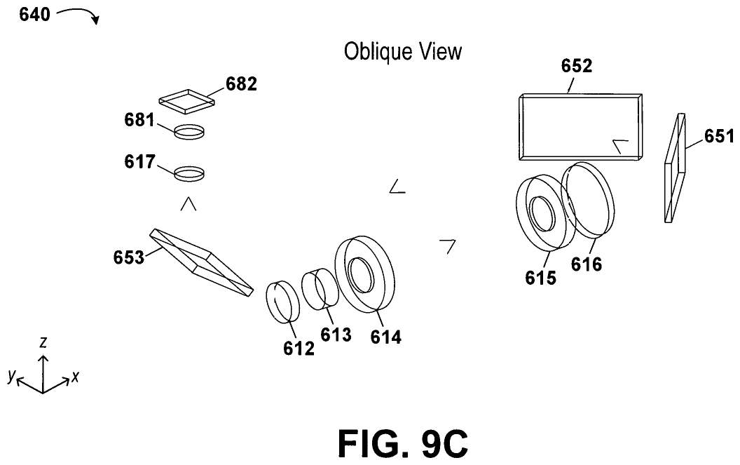

FIGS. 9A, 9B, and 9C show a top view, side view, and oblique view of the optical magnification system 600 illustrated in FIG. 6A, wherein 45-degree tilted mirrors 651, 652, 653 are utilized to divert the optical path. The overall length of the system is reduced with three mirrors 651, 652, 653. The mirrors 651 and 652 are tilted 45 degrees towards the y-z plane and perpendicular to each other. The mirror 651 is facing the object plane while the mirror 652 is facing the intermediate plane. The system further comprises a mirror 653 that is tilted 45 degrees toward the x-y plane. The change of the direction of the optical axis subsequently changes the orientation of the eyepiece and the camera module. Thus, the camera module can be arranged to be horizontally placed. This may make the overall system more compact and miniaturized. It will be understood that other optical arrangements (e.g., involving different orientations, different optical elements, etc.) are possible within the scope of the present disclosure.

### III. Example Processes

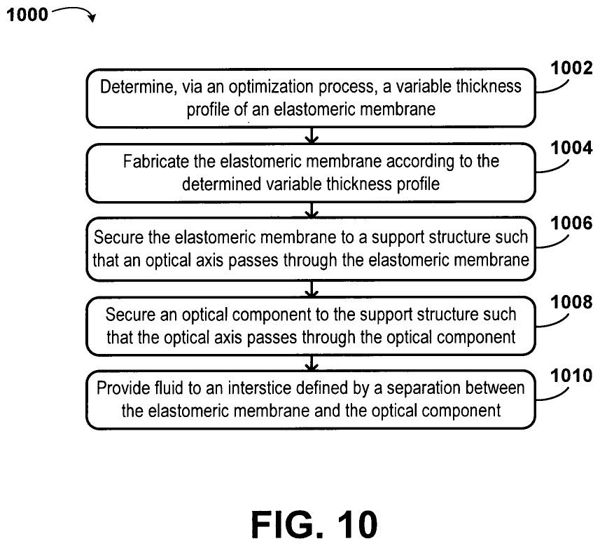

FIG. 10 is a flow chart illustrating a method 1000. The method 1000 may be used to manufacture an optical system, such as the optical system 100 illustrated in FIGS. 1A-1C, for example.

At block 1002, the method 1000 may include determining, via an optimization process, a variable thickness profile of an elastomeric membrane. The variable thickness profile may be defined such that a center region of the elastomeric membrane has a different thickness (e.g., a greater thickness or a smaller thickness) than a peripheral region of the elastomeric membrane. The elastomeric membrane may be the elastomeric membrane 101 illustrated in FIGS. 1A-1D, the elastomeric membrane 191 illustrated in FIG. 1E, or the elastomeric membrane 161 illustrated in FIG. 1F, for example. Further, in some embodiments, the variable thickness profile may be one of the variable thickness profiles 181, 182 illustrated in FIG. 1D. In some embodiments, the variable thickness profile may be one of the variable thickness profiles 196, 197 illustrated in FIG. 1E or a variable thickness profile of one of the elastomeric membranes 161 illustrated in FIG. 1F.

At block 1004, the method 1000 may include fabricating the elastomeric membrane according to the determined variable thickness profile. Fabricating the elastomeric membrane may include replication against a pre-fabricated master mold (e.g., using injection molding). The master mold may be created using a wide spectrum of manufacturing technologies, including, but not limited to, lithography, ultra-precision machining, diamond cutting, and diamond turning.

At block 1006, the method 1000 may include securing the elastomeric membrane to a support structure such that an optical axis passes through the elastomeric membrane. The support structure may be the support structure 102 illustrated in FIGS. 1A-1C, for example.

At block 1008, the method 1000 may include securing an optical component to the support structure such that the optical axis passes through the optical component. In various embodiments, the optical component may be one of the elastomeric membranes 101 (e.g., the bottom elastomeric membrane) illustrated in FIGS. 1A and 1C, the lens 205 illustrated in FIGS. 2A and 2C, or the optical window 304 illustrated in FIGS. 3A and 3C.

At block 1010, the method 1000 may include providing fluid to an interstice defined by a separation between the elastomeric membrane and the optical component. The fluid may be confined by the support structure. The interstice may be the interstice 103 illustrated in FIGS. 1A and 1C, for example.

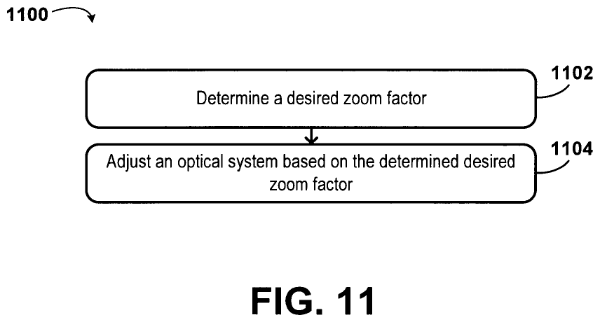

FIG. 11 is a flow chart illustrating a method 1100. The method 1100 may be used to zoom in or out using an optical magnification system (e.g., the optical magnification systems 600, 602, 604, 606, 608 illustrated in FIGS. 6A-6E).

At block 1102, the method 1100 may include determining a desired zoom factor. The zoom factor may correspond to a zoom value that is greater than 1.0 in magnitude or less than 1.0 in magnitude (e.g., between 0.33 and 3.0).

At block 1104, the method 1100 may include adjusting an optical system based on the determined desired zoom factor. Adjusting the optical system includes adjusting a conformation of a first elastomeric membrane of a first elastomer-fluid lens to modify a focal length of the first elastomer-fluid lens. In addition, adjusting the optical system includes adjusting a conformation of a second elastomeric membrane of a second elastomer-fluid lens to modify a focal length of the second elastomer-fluid lens. The optical system is adjusted such that collimated light entering the first elastomer-fluid lens is deflected according to the determined desired zoom factor and is directed toward the second elastomer-fluid lens. Light directed to the second elastomer-fluid lens is re-collimated by the second elastomer-fluid lens. The first elastomer-fluid lens may include a first elastomeric membrane (e.g., similar to the elastomeric membranes 101 illustrated in FIGS. 1A-1D, the elastomeric membranes 191 illustrated in FIG. 1E, or the elastomeric membranes 161 illustrated in FIG. 1F). The second elastomer-fluid lens may include a second elastomeric membrane (e.g., similar to the elastomeric membranes 101 illustrated in FIGS. 1A-1D, the elastomeric membranes 191 illustrated in FIG. 1E, or the elastomeric membranes 161 illustrated in FIG. 1F).

### IV. Conclusion

The above detailed description describes various features and functions of the disclosed systems, devices, and methods with reference to the accompanying figures. While various aspects and embodiments have been disclosed herein, other aspects and embodiments will be apparent. The various aspects and embodiments disclosed herein are for purposes of illustration only and are not intended to be limiting, with the true scope being indicated by the following claims.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

1. An optical system, comprising:
a support structure;
an elastomeric membrane having a variable thickness profile, wherein an optical axis passes through the elastomeric membrane, wherein the elastomeric membrane is secured to the support structure, and wherein the variable thickness profile is defined such that a center region of the elastomeric membrane has a greater thickness than a peripheral region of the elastomeric membrane,
an optical component secured to the support structure, wherein the optical axis passes through the optical component; and
a fluid disposed in an interstice defined by a separation between the elastomeric membrane and the optical component, wherein the fluid is confined by the support structure.

2. The optical system of claim 1,
wherein the elastomeric membrane has a substantially circular shape with respect to the optical axis, and
wherein the optical component has a substantially circular shape with respect to the optical axis.

3. (canceled)

4. The optical system of claim 1, wherein the variable thickness profile is defined based on a thickness profile of a pre-fabricated master mold against which the elastomeric membrane was replicated.

5. The optical system of claim 1,
wherein the variable thickness profile is created by lithography, ultra-precision machining, diamond cutting, or diamond turning.

6. The optical system of claim 1, further comprising:
a top mounting cell inlaid with a top cover glass; and
a bottom mounting cell inlaid with a bottom cover glass,
wherein the bottom mounting cell is adhered to a base of the top mounting cell, and
wherein the variable thickness membrane is suspended between the top cover glass of the top mounting cell and the bottom cover glass of the bottom mounting cell.

7. The optical system of claim 1, wherein the variable thickness profile is asymmetric about an axis that passes through a center point of the elastomeric membrane and is perpendicular to a surface of the elastomeric membrane.

8. The optical system of claim 1, wherein the optical component comprises an additional elastomeric membrane having an additional variable thickness profile.

9. (canceled)

10. (canceled)

11. The optical system of claim 1, wherein the optical component comprises an optical lens or a planar optical window.

12. (canceled)

13. A method of manufacturing the optical system of claim 1, comprising:
determining, via an optimization process, a variable thickness profile of an elastomeric membrane, wherein the variable thickness profile is defined such that a center region of the elastomeric membrane has a greater thickness than a peripheral region of the elastomeric membrane;
fabricating the elastomeric membrane according to the determined variable thickness profile;
securing the elastomeric membrane to a support structure such than an optical axis passes through the elastomeric membrane;
securing an optical component to the support structure such that the optical axis passes through the optical component and
providing fluid to an interstice defined by a separation between the elastomeric membrane and the optical component, wherein the fluid is confined by the support structure.

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. An optical system, comprising:
a first elastomer-fluid lens comprising a first elastomeric membrane; and
a second elastomer-fluid lens comprising a second elastomeric membrane,
wherein the first elastomer-fluid lens and the second elastomer-fluid lens are disposed about an optical axis,
wherein the first elastomer-fluid lens is disposed such that collimated light entering the first elastomer-fluid lens is deflected according to a desired zoom factor and is directed toward the second elastomer-fluid lens, and
wherein the second elastomer-fluid lens is disposed such that light from the first elastomer-fluid lens is re-collimated.

28. (canceled)

29. (canceled)

30. The optical system of claim 27,
wherein the first elastomeric membrane is disposed on a first side of the first elastomer-fluid lens that faces away from the second elastomer-fluid lens, and
wherein the second elastomeric membrane is disposed on a second side of the second elastomer-fluid lens that faces away from the first elastomer-fluid lens.

31. (canceled)

32. The optical system of claim 27,
wherein the first elastomeric membrane has a variable thickness profile, and
wherein the second elastomeric membrane has a variable thickness profile.

33. (canceled)

34. (canceled)

35. (canceled)

36. The optical system of claim 27, further comprising one or more solid lenses disposed about the optical axis, wherein a zoom factor of the optical system is determined by optical powers of: the first elastomer-fluid lens, the second elastomer-fluid lens, or the one or more solid lenses.

37. The optical system of claim 36, wherein the zoom factor is a continuously variable zoom factor configured to be varied by changing the optical power of the first elastomer-fluid lens or the optical power of the second elastomer-fluid lens.

38. The optical system of claim 27, wherein the optical system is a component of a microscope, a magnifier, a telescope, or a macroscopic imaging tool.

39. The optical system of claim 27, wherein the optical system is integrated into a smartphone, a mobile computing device, or a tablet computing device.

40. (canceled)

41. The optical system of claim 27, further comprising one or more mirrors configured to direct the re-collimated light from the second elastomer-fluid lens to an image sensor.

42. (canceled)

43. The optical system of claim 27, further comprising:
one or more objective lenses,
wherein the one or more objective lenses comprise a transparent rigid material, and
wherein the transparent rigid material comprises glass, poly(methyl methacrylate), or polycarbonate;
an eyepiece disposed between the second elastomer-fluid lens and an image plane;
a tube lens disposed along the optical axis on a side of the second elastomer-fluid lens that is opposite the first elastomer-fluid lens; and
an image sensor disposed along the optical axis at the image plane to record an image.

44. (canceled)

45. The optical system of claim 27,
wherein a fluid of the first elastomer-fluid lens has a high abbe number and a refractive index close to a refractive index of the first elastomeric membrane,
wherein the fluid of the first elastomer-fluid lens is stable, nonvolatile, freeze-resistant, heat-resistant, and not reactive with the first elastomeric membrane,
wherein a fluid of the second elastomer-fluid lens has a high abbe number and a refractive index close to a refractive index of the second elastomeric membrane, and
wherein the fluid of the second elastomer-fluid lens is stable, nonvolatile, freeze-resistant, heat-resistant, and not reactive with the second elastomeric membrane.

46. (canceled)

47. (canceled)

48. (canceled)

49. A method of zooming, comprising:
determining a desired zoom factor; and
adjusting an optical system based on the determined desired zoom factor,
wherein adjusting the optical system comprises:
adjusting a conformation of a first elastomeric membrane of a first elastomer-fluid lens to modify a focal length of the first elastomer-fluid lens; and
adjusting a conformation of a second elastomeric membrane of a second elastomer-fluid lens to modify a focal length of the second elastomer-fluid lens,
wherein the optical system is adjusted such that collimated light entering the first elastomer-fluid lens is deflected according to the determined desired zoom factor and is directed toward the second elastomer-fluid lens, and
wherein light directed to the second elastomer-fluid lens is re-collimated by the second elastomer-fluid lens.
